(19) United States
(12) Patent Application Publication
(10) Pub. No.: US 2014/0262720 A1
(43) Pub. Date: Sep. 18, 2014

(54) Sealed Switch Apparatus and Systems and Methods for Using the Same

(71) Applicant: APPLE INC., Cupertino, CA (US)

(72) Inventor: Michael T. Nawrot, Cambridge, CT (US)

(73) Assignee: Apple Inc., Cupertino, CA (US)

(21) Appl. No.: 13/834,583

(22) Filed: Mar. 15, 2013

(51) Int. Cl. H01H 1/64; H01H 11/06; H01H 15/10

(52) U.S. Cl. CPC H01H 1/64; H01H 15/10; H01H 11/06
USPC 200/550; 200/302.1; 29/622

(57) ABSTRACT

A sealed switch apparatus and systems and methods for using the same are disclosed. A sealed switch apparatus may include a sealed contact structure and a switch mechanism operable to apply a force to the switch mechanism to trigger a switch event. The sealed contact structure may include a sealing layer operative to seal electrical contacts disposed within the contact structure from external debris and to transfer the force applied from the switch mechanism to at least one of the electrical contacts. The transferred force may deflect that electrical contact to interact with another one of the electrical contacts, and the deflection may provide tactile feedback to a user.

### FIELD OF THE INVENTION

This relates to a sealed switch apparatus and systems and methods for using the same.

### BACKGROUND OF THE DISCLOSURE

Many electronic devices include switches that can be flipped by a user to occupy different states. For example, some devices include a ringer switch that allows a user to control whether the device rings or vibrates when an incoming call is received by the device. The typical ringer switch includes a flip switch configured to couple two fixed contacts when the flip switch is occupying a first state, and leave open the two fixed contacts when the flip switch is occupying a second state. To provide tactile feedback to a user when the user moves the flip switch, the ringer switch also includes a retention mechanism that interacts with a portion of the flip switch when the flip switch is moved between the first and second states. However, because the ringer switch is not typically designed to include a protective seal, the various components of the ringer switch are susceptible to environmental debris (e.g., water, dust, etc.), which may affect their operation. Thus, it may be advantageous to provide an electronic device that includes one or more sealed switches.

### SUMMARY OF THE DISCLOSURE

Sealed switch apparatus and systems and methods for using the same are provided.

In some embodiments, a sealed switch may be provided. The sealed switch may include a switch mechanism having a slide component coupled to a rotatable member and a sealed contact structure having a structural frame, a plurality of electrically conductive contacts disposed in the structural frame, and a seal disposed on the structural frame to at least partially cover the plurality of contacts. The seal may be operative to interact with a first contact of the plurality of contacts. The rotatable member may be operative to displace the seal to cause the first contact to interact with a second contact of the plurality of contacts, in response to an external force being applied to the slide component.

In some embodiments, a switch mechanism for a switch apparatus may be provided. The switch mechanism may include a base plate having an opening that spans from a first side of the base plate to a second side of the base plate, a slide unit disposed on the first side, and a roller disposed on the second side and coupled to the slide unit through the opening. The roller may be operative to move when the slide unit is moved.

In some embodiments, a sealed contact structure for a switch apparatus may be provided. The sealed contact structure may include a frame having an opening and a plurality of contacts disposed within the frame. A first contact of the plurality of contacts may be disposed adjacent the opening. The sealed contact structure may also include a sealing layer residing over the opening and operative to interact with the first contact through the opening, in response to a force being applied to the sealing layer.

In some embodiments, a method of manufacturing a sealed contact structure may be provided. The method may include positioning a first contact away from a second contact by a predefined distance. The method may also include integrating each of the first contact and the second contact to a frame such that a first portion of the first contact may be fixed to the frame, and a second portion of the first contact may be (i) exposed in an opening of the frame and (ii) free to move within the frame to interact with the second contact over the predefined distance. The method may also include disposing a sealing layer onto the frame to seal the opening.

In some embodiments, an electronic device may be provided. The electronic device may include a housing having a switch opening and a switch apparatus coupled to the switch opening and including a slide mechanism and a contacts component. The contacts component may include a pair of electrical contacts sealed from the slide mechanism by a seal, and the slide mechanism may be operative to interact with the seal to cause the pair of contacts to trigger a switch event.

In some embodiments, a method of integrating a sealed switch apparatus with a device may be provided. The method may include securing a sealed contact structure of the switch apparatus to an inner bracket, coupling an outer bracket to the inner bracket to sandwich the secured sealed contact structure between the outer bracket and the inner bracket, and situating a slide mechanism of the switch apparatus adjacent to an opening of a housing of the device. The method may also include fixing the inner bracket to the housing to sandwich the inner bracket, the sealed contact structure, and at least a portion of the slide mechanism between the inner bracket and the housing.

### BRIEF DESCRIPTION OF THE DRAWINGS

The above and other aspects and advantages of the invention will become more apparent upon consideration of the following detailed description, taken in conjunction with accompanying drawings, in which like reference characters refer to like parts throughout, and in which:

FIG. 1A is perspective view of a sealed switch apparatus that includes a switch mechanism and a sealed contact structure, in accordance with at least one embodiment;

FIG. 1B is an exploded view of the sealed switch apparatus of FIG. 1A, in accordance with at least one embodiment;

FIG. 1C is a rear perspective view of a set of contacts of the sealed contact structure OF FIG. 1A, in accordance with at least one embodiment;

FIG. 1D is a cross-sectional view of a portion of the set of contacts of FIG. 1C, in accordance with at least one embodiment;

FIG. 1E is a front perspective view of the sealed contact structure of FIG. 1A, in accordance with at least one embodiment;

FIG. 1F is a similar front perspective view of the sealed contact structure of FIG. 2A, but without a sealing layer, in accordance with at least one embodiment;

FIG. 1G is a cross-sectional view of a portion of the sealed switch apparatus of FIG. 1A in a first state, in accordance with at least one embodiment;

FIG. 1H is a similar cross-sectional view of the portion of the sealed switch apparatus of FIG. 1A in a second state, in accordance with at least one embodiment;

FIG. 2 is an inner view of an electronic device configured to integrate with a sealed switch apparatus, in accordance with at least one embodiment;

FIG. 3A is an inner view of an electronic device integrated with a sealed switch apparatus via an outer bracket, an inner bracket, and a peripheral seal, in accordance with at least one embodiment;

FIG. 3B is a similar inner view of the electronic device of FIG. 3A, but without the inner bracket, in accordance with at least one embodiment;

FIG. 3C is a cross-sectional view of the electronic device of FIG. 3A, in accordance with at least one embodiment;

FIG. 3D is a perspective view of a switch mechanism of the sealed switch apparatus of FIG. 3A coupled to the outer bracket of FIG. 3A via intermediate layers, in accordance with at least one embodiment;

FIG. 4 is an illustrative process for manufacturing a sealed contact structure, in accordance with at least one embodiment; and

FIG. 5 is an illustrative process for integrating an electronic device with a sealed switch apparatus, in accordance with at least one embodiment.

### DETAILED DESCRIPTION OF THE DISCLOSURE

A sealed switch apparatus and systems and methods for using the same are described with reference to FIGS. 1-5 (where FIG. 1, for example, refers collectively to FIGS. 1A-1H, etc.).

As described above, it may be desirable to provide an electronic device that includes one or more sealed switches. To prevent external debris from interfering with the operation of a switch's components, in some embodiments, a sealed switch apparatus may be provided. The sealed switch apparatus may include a switch mechanism and a sealed contact structure. The switch mechanism may include a slide component coupled to a roller and operative to move linearly to occupy various positions. The roller may move linearly with the flip switch, as well as rotationally when the roller is interfaced with an object.

The sealed contact structure may include a set of contacts integrated within a frame. One of the contacts may be completely fixed in position in the frame, and another one of the contacts may be partially fixed in position and may include a portion that may move about freely in the frame like a cantilever. This cantilever contact may include a bump or mound, and may move towards and interact with the fixed contact when a force is applied to or around the mound. The mound may be disposed adjacent to an opening of the frame that may be sealed with a sealing layer.

The roller of the switch mechanism may be placed in contact with the sealing layer of the sealed contact structure, and may be manipulated via the slide component to cause the cantilever contact to either interact with or not interact with the fixed contact. For example, when the slide component is moved to a first position near the mound of the cantilever contact, the roller may move correspondingly, and may compress and/or displace the sealing layer onto the mound to cause the cantilever contact to interact with the fixed contact. When the slide component is moved to a second position away from the mound, the roller may only compress and/or displace a portion of the sealing layer positioned away from the mound, and thus, may not cause the sealing layer to interact with the mound.

In some embodiments, the cantilever contact may also be configured and shaped such that movement of the slide component between the first and second positions may cause the cantilever contact to snap, deflect, or otherwise deform, which may provide tactile feedback to a user.

FIG. 1A is a perspective view of a sealed switch apparatus 100. FIG. 1B is an exploded view of sealed switch apparatus 100. Sealed switch apparatus 100 may include a switch mechanism 110 and a sealed contact structure 120. Switch mechanism 110 may include a slide or flip switch component 111 and a rotatable member or roller 116. Flip switch 111 may be at least partially composed of metal, and may include any user controllable switch component (e.g., a cosmetic switch) that may occupy and transition between two or more states or positions. Flip switch 111 may include a switch base plate 112 and a slide component 113 that may be disposed on one side of switch base plate 112. Flip switch 111 may also include a roller holder 114 (e.g., a rigid metal or plastic component) that may be disposed on an opposite side of switch base plate 112, and that may be coupled to slide component 113. More particularly, roller holder 114 may extend from slide component 113 and through a base hole 115 of switch base plate 112 to the opposite side.

Roller 116 may include a roller contact surface 117 disposed between roller support legs 118. Roller holder 114 may be configured to retain roller legs 118 in a loose fit (e.g., at a predefined looseness or tightness). When slide component 113 is moved (e.g., by a user) along the Z-axis, roller holder 114 and roller 116 may similarly move along the Z-axis. Because roller holder 114 may retain roller 116 in a loose fit, roller contact surface 117 may also simultaneously rotate upon contact with an object or surface.

It should be appreciated that, although FIG. 1A may show roller holder 114 and roller 116 each having a particular shape, they may each have any shape, or include any structural components, as long as roller holder 114 retains roller 116 while allowing roller 116 to roll or rotate (and thus, while the shape of roller 116 can vary, it needs to be such that roller 116 can roll or rotate).

Switch mechanism 110 may be coupled to sealed contact structure 120, as shown in FIG. 1A. When coupled, roller 116 may interact with sealed contact structure 120 such that the linear, rotational, or a combination of linear and rotational movements of roller 116 may apply corresponding forces to sealed contact structure 120.

Sealed contact structure 120 may include a set of electrically conductive contacts 130. FIG. 1C is a rear perspective view of the set of contacts 130. The set of contacts 130 may include a stationary contact 137 and a deformable or deflectable contact 131. Stationary contact 137 may be composed of any suitable conductive material (e.g., copper or other type of metal). Stationary contact 137 may include a stationary beam 138 extending along the Y-axis and including an electrical pad 139.

Deflectable contact 131 may be similar to stationary contact. More particularly, deflectable contact 131 may include a similar longitudinal beam 132 extending along the Y-axis and including a similar electrical pad 133. However, deflectable contact 131 may also include a transition or deflectable arm 134 extending away from longitudinal beam 132 in the −Z-direction. Deflectable arm 134 may include a bump or mound 135 in the −X-direction.

To accommodate deflectable arm 134, stationary contact 137 and deflectable contact 131 may be oriented with respect to each other such that stationary beam 138 may contour in the −X-direction leading to electrical pad 139, and longitudinal beam 132 may contour in the +X-direction leading to electrical pad 133 (e.g., as shown in FIG. 1C). Oriented in this manner, deflectable arm 134 may extend in the −Z-direction without touching stationary beam 138. More particularly, deflectable arm 134 may be spaced apart from stationary beam 138 by a predefined distance 130D.

Deflectable arm 134 may also be contoured. FIG. 1D is a cross-sectional view of the set of contacts 130 along a line 192-193 of FIG. 1C. As shown in FIG. 1D, a portion of deflectable arm 134 adjacent mound 135 in the +Z-direction may be shifted from a portion of deflectable arm 134 adjacent mound 135 in the −Z-direction. More particularly, these portions of deflectable arm 134 may be shifted from one another along the X-axis.

When stationary contact 137 and deflectable contact 131 are oriented as shown in FIGS. 1C and 1D, and when longitudinal beams 138 and 132 are fixed in positioned (e.g., by a frame, described below), contacts 130 may be controllable to interact with or separate from one another via deflectable arm 134. That is, contacts 130 may be controllable to trigger switching events. For example, when no force is received by deflectable arm 134 in the +X-direction, deflectable arm 134 may remain in its initial position as shown in FIGS. 1C and 1D. As another example, when a force is received by a portion of deflectable arm 134 between mound 135 and longitudinal beam 132, deflectable arm 134 may act as a cantilever and deflect in the +X-direction, and may, as a result, contact, couple to, or otherwise interact with stationary beam 138 (e.g., to close a circuit). As yet another example, when a force is received by a portion of deflectable arm 134 beyond mound 135 in the −Z-direction, deflectable arm 134 may one of remain in its initial position and deflect only slightly in the +X-direction without touching stationary beam 138.

To maintain the positions of stationary contact 137 and deflectable contact 131 as shown in FIGS. 1C and 1D, sealed contact structure 120 may include a frame 121. Frame 121 may be composed of any suitable type of material (e.g., plastic), and may at least partially enclose and retain contacts 137 and 131. In some embodiments, contacts 137 and 131 may be insert-molded into frame 121 (e.g., frame 121 and contacts 137 and 131 may be combined into a single component by injecting thermoplastic around carefully positioned contacts 137 and 131). As shown in FIG. 1C, for example, each of contacts 137 and 131 may include respective insert molding holes 136 that may be configured to allow insert molding of contacts 137 and 131 into frame 121. In other embodiments, frame 121 may be separately provided with recesses for accommodating contacts 137 and 131.

FIG. 1E is a front perspective view of sealed contact structure 120 that includes a sealing layer 127, and FIG. 1F is a similar front perspective view of sealed contact structure 120, but without sealing layer 127 (e.g., prior to sealing layer 127 being disposed on frame 121 to cover opening 124). When housed by frame 121, each one of longitudinal beams 138 and 132 may be fixed or secured in position within frame 121, while deflectable arm 134 may remain free to move about along the X-axis to allow interaction between and separation of contacts 137 and 131. Moreover, to provide a switching function for a circuit board (not shown), frame 121 may be configured to expose the respective electrical pads 139 and 133 of contacts 137 and 131, via respective frame contact openings 125 (as shown in FIGS. 1E and 1F, such that contacts 137 and 131 may be electrically connectable to corresponding electrical contacts of the circuit board). The circuit board may, for example, be coupled to control circuitry that may switch between various ringer or vibrate modes of a corresponding electronic device, depending on whether a circuit is OPEN or CLOSED (e.g., depending on whether contacts 137 and 131 are OPEN or CLOSED (e.g., connected or separated)). In such a configuration, when a force is received by the portion of deflectable arm 134 between mound 135 and longitudinal beam 132, deflectable arm 134 may deflect and interact with stationary beam 138, and as a result, the circuit of the circuit board may be CLOSED. Moreover, when a force is received by the portion of deflectable arm 134 beyond mound 135 in the −Z-direction, deflectable arm 134 may one of remain in its initial position and deflect only slightly in the +X-direction without touching stationary beam 138, and as a result, the circuit of the circuit board may be OPEN.

It should be appreciated that, although deflectable contact 131 may be configured such that deflectable arm 134 may deflect when a force is received by a portion of deflectable arm 134 between mound 135 and longitudinal beam 132, and such that deflectable arm 134 may not or only minimally deflect when a force is received by a portion of deflectable arm 134 beyond mound 135 in the −Z-direction, in some embodiments, deflectable contact 131 may be oriented differently. For example, in some embodiments, deflectable contact 131 may instead be oriented such that deflectable arm 134 may not or may only minimally deflect when a force is received by a portion of deflectable arm 134 between mound 135 and longitudinal beam 132, and such that deflectable arm 134 may deflect when a force is received by a portion of deflectable arm 134 beyond mound 135 in the −Z-direction. In these embodiments, for example, deflectable arm 134 may be contoured such that the portion of deflectable arm 134 beyond mound 135 in the −Z-direction may be shifted in the −X-direction from the portion of deflectable arm 134 between mound 135 and longitudinal beam 132.

As shown in FIG. 1F, frame 121 may also be configured to expose, via an opening 124, at least a portion of deflectable arm 134 to allow deflectable arm 134 to receive external forces for controlling switching events. However, to prevent external debris from interfering with the operation of contacts 137 and 131, opening 124 may be sealed with sealing layer 127, as shown in FIG. 1E. Sealing layer 127 may function as a force transfer component that may transfer external forces to the deflectable arm 134. For example, when an external force is applied to sealing layer 127 in the +X-direction, sealing layer 127 may compress or displace in the +X-direction towards a corresponding portion of deflectable arm 134. In this manner, contacts 137 and 131 may be sealed from external debris, while still remaining controllable to interact with or separate from one another.

Sealing layer 127 may be composed of flexible or deformable material (e.g., rubber), and may be water-proof. Sealing layer 127 may also have a predefined thickness 127t and may be tuned to be compressible along the X-axis. Frame 121 may include a set of seal compression control pins 126 that may each contact, couple to, or otherwise interact with a corresponding seal hole 128 of sealing layer 127. For example, each seal compression control pin 126 may snug fit in the corresponding seal hole 128, which can provide a tight seal of opening 124, but may not protrude all the way through seal hole 128. Compression control pins 126 can serve at least three independent purposes. For example, compression control pins 126 can align sealing layer 127 to frame 121. As another example, compression control pin 126 can mechanically fasten sealing layer 127 to frame 121. As yet another example, compression control pins 126 can limit the compression of sealing layer 127 when sealed contact structure 120 is installed in a device. Compression control pins 126 can limit this compression by, for example, adjusting the relative length of the compression control pins 126 to thickness 127t (e.g., the compression control pins 126 can be about 50% of thickness 127t in the −X-direction). In some embodiments, sealing layer 127 may, additionally or alternatively, be coupled to frame 121 via one or more adhesives 129 (e.g., a pressure sensitive adhesive “PSA”). In other embodiments, sealing layer 127 may be insert-molded or over-molded into frame 121.

As described above with respect to FIGS. 1A and 1B, switch mechanism 110 may be coupled to sealed contact structure 120, and may be configured to apply forces to sealed contact structure 120 via movement of flip switch 111 and roller 116. FIG. 1G is a cross-sectional view, taken from a line 190-191 of FIG. 1A, of a portion of sealed switch apparatus 100 in a first state. As shown in FIG. 1G, roller 116 may be occupying a first position adjacent a portion of deflectable arm 134 beyond mound 135 in the −Z-direction, and may be compressing or displacing a corresponding portion of sealing layer 127 in the +X-direction towards the portion of deflectable arm 134. However, because this portion of deflectable arm 134 may be shifted slightly in the +X-direction (as described above with respect to FIGS. 1C and 1D), and thus, may be farther from sealing layer 127, sealing layer 127 may not be compressed or displaced sufficiently to deflect deflectable arm 134 to interact with stationary contact 137. As a result, the circuit of the circuit board (not shown) may remain open when roller 116 is occupying the first position.

FIG. 1H is a similar cross-sectional view, taken from line 190-191 of FIG. 1A, of the portion of the sealed switch apparatus 100 in a second state. As shown in FIG. 1H, roller 116 may be occupying a second position adjacent a portion of deflectable arm 134 between mound 135 and longitudinal beam 132, and may be compressing or displacing a corresponding portion of sealing layer 127 in the +X-direction onto the portion of deflectable arm 134. Because this portion of deflectable arm 134 may be shifted slightly in the +X-direction (as described above with respect to FIGS. 1C and 1D), and thus, may be closer to sealing layer 127, sealing layer 127 may sufficiently deflect deflectable arm 134 in the +X-direction to cause deflectable arm 134 to interact with stationary contact 137. As a result, the circuit of the circuit board (not shown) may close when roller 116 is occupying the second position.

When roller 116 is positioned adjacent mound 135, it should be appreciated that roller 116 may tend to roll or travel towards either the first position of roller 116 (as shown in FIG. 1G) or the second position of roller 116 (as shown in FIG. 1H), depending on whether a force being applied to slide component 113 or flip switch 111 is larger in the +Z-direction or in the −Z-direction. Mound 135 may serve to provide tactile feedback to a user when flip switch 111 is moved. In particular, as a result of transitions between the first position and the second position, roller 116 may cause deflectable arm 134 to deflect and undeflect. This deflection and undeflection of deflectable arm 134 may be felt by a user and may make the user aware of switching events.

As described above with respect to FIG. 1E, sealing layer 127 may be tuned to be compressible along the X-axis. In some embodiments, sealing layer 127 may also be tuned such that it experiences minimal or no drag or compression forces along the Z-axis, when roller 116 moves linearly along the Z-axis and rolls over sealing layer 127. In this manner, the integrity of sealing layer 127 may be maintained over a long period of time without affecting its ability to seal opening 124 of frame 121.

As shown in FIGS. 1A and 1B, frame 121 may also include a set of frame posts 123 that may protrude from a body of frame 121, and that may be configured contact, couple to, or otherwise interact with one or more securing brackets (described below). For example, each of frame posts 123 may be heat-staked to a metallic securing bracket in order to retain sealed contact structure 120 in place within an electronic device.

In some embodiments, an electronic device may be configured to integrate with a sealed switch apparatus. FIG. 2 is an inner view of an electronic device 200 configured to integrate with a sealed switch apparatus. As shown in FIG. 2, electronic device 200 may include a housing 201 having a switch opening 203 through which at least a portion of a flip switch of the sealed switch apparatus may pass. An inner portion 202 of housing 201 adjacent to switch opening 203 may be configured to retain and secure the flip switch and a sealed contact structure of the sealed switch apparatus. Housing 201 may also include a set of holes 204 for coupling (e.g., via screws) to bracket structures (not shown) that may secure the sealed switch apparatus within housing 201.

To integrate a sealed switch apparatus into an electronic device, various bracket and sealing structures may be utilized. FIG. 3A is an inner view of an electronic device 300 integrated with a sealed switch apparatus (not shown in FIG. 3A) via an outer bracket 350, an inner bracket 340, and a peripheral seal 360. FIG. 3B is a similar inner view of electronic device 300, but not showing inner bracket 340 in order to reveal a sealed contact structure 320 of the sealed switch apparatus. FIG. 3C is a cross-sectional view of electronic device 300, taken from a line 390-391 of FIG. 3A.

The sealed switch apparatus may be similar to sealed switch apparatus 100 of FIG. 1A. More particularly, the sealed switch apparatus may include components that may be similar to those of sealed switch apparatus 100 described above with respect to FIGS. 1A-1H. For the sake of clarity, the last two digits of each component of the sealed switch apparatus described with respect to FIGS. 3A-3D is intended to match the last two digits of each component of sealed switch apparatus 100 shown in FIGS. 1A-1H. As an example, switch mechanism 110 and sealed contact structure 120 of sealed switch apparatus 100 may include features similar to those of switch mechanism 310 and sealed contact structure 320. As another example, frame 121 of sealed contact structure 120 may include features similar to those of frame 321 of sealed contact structure 320.

Inner bracket 340 may be composed of metal (e.g., stainless steel), and may include a protective plate 340 that may be substantially flat. As shown in FIGS. 3A and 3C, for example, protective plate 341 may include a recess 342 that may be configured to receive at least a portion of sealed contact structure 320. More particularly, recess 342 of inner bracket 340 may include one or more corresponding recess holes 343 configured to receive one or more frame posts 323 of sealed contact structure 320 to secure sealed contact structure 320 to inner bracket 340. Inner bracket 340 may also include a set of coupling arms 345 extending from protective plate 341 for coupling to coupling holes 304 of an inner portion 302 of a housing 301 of electronic device 300. For example, each coupling arm 345 may include a coupling arm hole 346 for coupling (e.g., via a screw) to a corresponding one of the coupling holes 304 of housing 301.

As also shown in FIGS. 3A and 3C, electronic device 300 may include a circuit board 370 having a contact end 371 configured to electrically couple to each of an electrical pad 333 of a deflectable contact 331 of sealed contact structure 320, and an electrical pad (not shown) of a stationary contact 337 of sealed contact structure 320. Contact end 371 may be sandwiched between frame 321 of sealed contact structure 320 and outer bracket 350. The remaining portion of circuit board 370 may be disposed along a portion of housing 301.

As shown in FIGS. 3B and 3C, for example, outer bracket 350 may also include a similar protective plate 351. When outer bracket 350 and inner bracket 340 are combined, sealed contact structure 320 may be at least partially disposed therebetween. Protective plate 351 of outer bracket 350 may include a plate opening 353 (as shown in FIG. 3C) through which at least a portion of sealed contact structure 320 may pass. More particularly, plate opening 353 may be configured to expose at least a portion of a sealing layer 327 of sealed contact structure 320 that may be adjacent to a mound 335 of deflectable contact 331. A slide component 313 of switch mechanism 310 may be disposed adjacent to the exposed portion of sealing layer 327 such that a roller 316 of switch mechanism 310 may interact with sealing layer 327. Outer bracket 350 may also be coupled (e.g., welded) to inner bracket 340 at least at their respective ends to secure the sealed switch apparatus to housing 301.

FIG. 3D is a perspective view of switch mechanism 310 coupled to outer bracket 350 via intermediate layers 380. As shown in FIGS. 3C and 3D, protective plate 351 of outer bracket 350 may include a set of protruding arms 354 that may be configured to limit movement of switch mechanism 310 (e.g., flip switch 311 and roller 316) along a single axis (e.g., the Z-axis). Intermediate layers 380 may be disposed between a switch base plate 312 of switch mechanism 310 and outer bracket 350. Intermediate layers 380 may, for example, include a foam layer 381 and a slide layer 382. Each of foam layer 318 and slide layer 382 may include a respective opening (not shown) that may allow roller 316 to pass therethrough. Foam layer 381 may be composed of any suitable material that may provide a predefined cushion or “give” between switch mechanism 310 and outer bracket 350. Slide layer 382 may provide a surface upon which switch mechanism 310 may slide, and may be composed of metal (e.g., steel). In some embodiments, slide layer 382 may include a slippery Teflon coating that may allow the switch mechanism 310 to slide along the Z-axis.

Peripheral seal 360 may prevent external debris from entering beyond switch opening 303 of housing 301. As shown in FIGS. 3A-3C, peripheral seal 360 may be disposed between outer bracket 350 and an inner surface of housing 301 adjacent to switch opening 303 so as to surround each of the set of protruding arms 354 of outer bracket 350, intermediate layers 380, and switch base plate 312. Peripheral seal 360 may also include a set of structural pins 362 configured to contact, couple to, or otherwise interact with each of outer bracket 350 and inner bracket 340. More particularly, protective plates 351 and 341 may include a set of pin holes 352 and 344, respectively, that may align peripheral seal 360 to outer and inner bracket 350 and 340, and that may be configured to receive a corresponding structural pin 362.

In some embodiments, peripheral seal 360 may be similar to sealing layer 327 of sealed contact structure 320, but may have a larger thickness. For example, as with sealing layer 327, peripheral seal 360 may be tuned to be compressible along the X-axis. When outer and inner brackets 350 and 340 are secured to housing 302, may (e.g., via pin holes 352 and 344), corresponding end portions 360s of peripheral seal 360, and corresponding end portions 327s of sealing layer 327 may each be compressed at a respective predefined force to provide predefined sealing tightness. In some embodiments, the amount of securing force applied by housing 302 and outer and inner brackets 350 and 340 may also be predefined such that end portions 327s and 360s may not rip when forces are applied to sealing layer 327 and peripheral seal 360 in any direction.

Accordingly, an electronic device may be provided with a switch apparatus that seals off external debris.

FIG. 4 is an illustrative process 400 of manufacturing a sealed contact structure. Process 400 may begin at step 402. At step 404, the process may include positioning a first contact away from a second contact by a predefined distance. For example, step 404 may include positioning deflectable contact 131 away from stationary contact 137 by predefined distance 130D. In some embodiments, step 404 may also include orienting one of the first contact and the second contact such that the second portion of the first contact is adjacent to the second contact. For example, step 404 may include orienting one of deflectable contact 131 and stationary contact 137 such that deflectable arm 134 of deflectable contact 134 is adjacent to stationary contact 137.

At step 406, the process may include integrating each of the first contact and the second contact to a frame such that a first portion of the first contact is fixed to the frame, and a second portion of the first contact is (i) exposed in an opening of the frame and (ii) free to move within the frame to interact with the second contact over the predefined distance. For example, step 406 may include integrating each of deflectable contact 131 and stationary contact 137 to frame 121 such that longitudinal beam 132 of deflectable contact 131 is fixed to frame 121, and deflectable arm 134 of deflectable contact 131 is (i) exposed in opening 124 of frame 121 and (ii) free to move within frame 121 to interact with stationary contact 137 over predefined distance 130D. In some embodiments, step 406 may also include insert molding each of the first contact and the second contact into the frame. For example, step 406 may include insert molding each of deflectable contact 131 and stationary contact 137 into frame 121. Moreover, in some embodiments, step 406 may also include exposing respective electrical pads of the first contact and the second contact. For example, step 406 may include exposing respective electrical pads 133 and 139 of deflectable contact 131 and stationary contact 137.

At step 408, the process may include disposing a sealing layer onto the frame to seal the opening. For example, step 408 may include disposing sealing layer 127 onto frame 121 to seal opening 124. In some embodiments, step 408 may also include aligning a plurality of seal compression control pins of the frame with a corresponding plurality of seal holes of the sealing layer, and coupling the plurality of seal compression control pins to the corresponding plurality of seal holes. For example, step 408 may include aligning a plurality of seal compression control pins 126 of frame 121 with a corresponding plurality of seal holes 128 of sealing layer 127, and coupling the plurality of seal compression control pins 126 to the corresponding plurality of seal holes 128. In some embodiments, prior to step 408, the process may include applying an adhesive to one of the frame and the sealing layer. Subsequently, the process may also include sandwiching the applied adhesive between the frame and the sealing layer. For example, prior to step 408, the process may include applying an adhesive 129 to one of frame 121 and sealing layer 127. Subsequently, the process may also include sandwiching adhesive 129 between frame 121 and sealing layer 127.

FIG. 5 is an illustrative process 500 of integrating a sealed switch apparatus into an electronic device. Process 500 may begin at step 502. At step 504, the process may include securing a sealed contact structure of the switch apparatus to an inner bracket. For example, step 504 may include securing sealed contact structure 320 to inner bracket 340. In some embodiments, step 504 may also include securing the sealed contact structure to a recess of the inner bracket. For example, step 504 may also include securing sealed contact structure 320 to recess 342 of inner bracket 340. In some embodiments, step 504 may also include securing a post of the sealed contact structure to a corresponding hole in the inner bracket. For example, step 504 may also include securing posts 323 of sealed contact structure 320 to holes 343 in inner bracket 340. In some embodiments, the post may be secured to the hole via heat staking. For example, posts 323 may be secured to holes 343 via heat staking.

At step 506, the process may include coupling an outer bracket to the inner bracket to sandwich the secured sealed contact structure between the outer bracket and the inner bracket. For example, step 506 may include coupling outer bracket 350 to inner bracket 340 to sandwich sealed contact structure 320 between outer bracket 350 and inner bracket 340. In some embodiments, step 506 may also include welding the outer bracket to the inner bracket. For example, step 506 may also include welding outer bracket 350 to inner bracket 340. In some embodiments, the welding may include laser welding.

At step 508, the process may include situating a slide mechanism of the switch apparatus adjacent to an opening of a housing of the device. For example, step 508 may include situating slide mechanism 310 to switch opening 303 of housing 301 of device 300.

At step 510, the process may include fixing the inner bracket to the housing to sandwich the inner bracket, the sealed contact structure, and at least a portion of the slide mechanism between the inner bracket and the housing. For example, step 510 may include fixing inner bracket 340 to housing 301 to sandwich outer bracket 350, sealed contact structure 320, and at least a portion of slide mechanism 310 between inner bracket 340 and housing 301. In some embodiments, step 510 may also include screwing the inner bracket to the housing. For example, step 510 may also include screwing inner bracket 340 to housing 301.

In some embodiments, process 500 may also include fastening the sealed contact structure to a circuit board. For example, process 500 may also include fastening sealed contact structure 320 to circuit board 370. Moreover, in some embodiments, process 500 may also include integrating a plurality of intermediate layers between the slide mechanism and the outer bracket. For example, process 500 may also include integrating intermediate layers 380 between slide mechanism 310 and outer bracket 350. Additionally, in some embodiments, process 500 may also include molding a peripheral seal to the outer bracket around a portion of the slide mechanism and the intermediate layers. For example, process 500 may also include molding peripheral seal 360 to outer bracket 350 around slide component 311 of slide mechanism and intermediate layers 380.

It is to be understood that the steps of processes 400 of FIGS. 4 and 500 of FIG. 5 are merely illustrative, that existing steps in each of these processes be modified, added, rearranged, or omitted, and that one or more steps of process 400 may be included in process 500, and vice versa.

While there have been described a sealed switch apparatus and systems and methods for using the same, it is to be understood that many changes may be made therein without departing from the spirit and scope of the invention. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. It is also to be understood that various directional and orientational terms such as “up and “down,” “front” and “back,” “top” and “bottom,” “left” and “right,” “length” and “width,” and the like are used herein only for convenience, and that no fixed or absolute directional or orientational limitations are intended by the use of these words. For example, the devices of this invention can have any desired orientation. If reoriented, different directional or orientational terms may need to be used in their description, but that will not alter their fundamental nature as within the scope and spirit of this invention. Moreover, an electronic device constructed in accordance with the principles of the invention may be of any suitable three-dimensional shape, including, but not limited to, a sphere, cone, octahedron, or combination thereof.

Therefore, those skilled in the art will appreciate that the invention can be practiced by other than the described embodiments, which are presented for purposes of illustration rather than of limitation.

What is claimed is:

1. A sealed switch comprising:
a switch mechanism having a slide component coupled to a rotatable member; and
a sealed contact structure having a structural frame, a plurality of electrically conductive contacts disposed in the structural frame, and a seal disposed on the structural frame to at least partially cover the plurality of contacts, the seal being operative to interact with a first contact of the plurality of contacts, and the rotatable member being operative to displace the seal to cause the first contact to interact with a second contact of the plurality of contacts, in response to an external force being applied to the slide component.

2. The sealed switch apparatus claim 1, wherein rotatable member is operative to displace the seal by at least one of rolling and pressing onto the seal.

3. The sealed switch apparatus claim 1, wherein the structural frame comprises an opening, and wherein the seal is disposed to cover the opening and is operative to interact with the first contact through the opening.

4. The sealed switch apparatus claim 1, wherein the first contact comprises a mound, and wherein the seal is operative to interact with the mound, in response to the external force being applied to the slide component.

5. The sealed switch apparatus claim 1, wherein the first contact is operative to at least partially deflect to provide predefined tactile feedback, in response to the external force being applied to the slide component.

6. The sealed switch apparatus claim 1, wherein the first contact is operative to interact with the second contact by displacing in a first direction, when the external force is applied to the slide component in a second direction that is substantially orthogonal to the first direction.

7. The sealed switch apparatus claim 1, wherein the first contact is operative to interact with the second contact structure without the first contact directly contacting any one of the slide component and the rotatable member.

8. A switch mechanism for a switch apparatus, the switch mechanism comprising:
a base plate having an opening that spans from a first side of the base plate to a second side of the base plate;
a slide unit disposed on the first side; and
a roller disposed on the second side and coupled to the slide unit through the opening, the roller being operative to move when the slide unit is moved.

9. The switch mechanism of claim 8 further comprising a roller holder, wherein the roller is coupled to the slide unit via the roller holder.

10. The switch mechanism of claim 9, wherein the roller holder is operative to retain the roller at a predefined looseness such that the roller is rotatable.

11. The switch mechanism of claim 9, wherein the roller comprises a roller contact surface and a pair support legs positioned adjacent to the roller contact surface, and wherein the roller holder is shaped to receive the pair of support legs.

12. The switch mechanism of claim 8, wherein the first side of the base plate is opposite the second side of the base plate.

13. A sealed contact structure for a switch apparatus, the sealed contact structure comprising:
a frame having an opening;
a plurality of contacts disposed within the frame, a first contact of the plurality of contacts being disposed adjacent the opening; and
a sealing layer residing over the opening and operative to interact with the first contact through the opening, in response to a force being applied to the sealing layer.

14. The sealed contact structure of claim 13, wherein the plurality of contacts is insert molded into the frame.

15. The sealed contact structure of claim 13, wherein the frame comprises plastic.

16. The sealed contact structure of claim 13, wherein the plurality of contacts is electrically conductive.

17. The sealed contact structure of claim 13, wherein a first portion of the first contact is fixed in position within the frame and a second portion of the first contact is free to move within the frame.

18. The sealed contact structure of claim 13, wherein the first contact is operative to interact with a second contact of the plurality of contacts, in response to the force being applied to the sealing layer.

19. The sealed contact structure of claim 18, wherein the first contact comprises a deflectable arm operative to interact with the second contact.

20. The sealed contact structure of claim 19, wherein the deflectable arm comprises a mound, and wherein the sealing layer is operative to interact with the first contact by interacting with the mound.

21. The sealed contact structure of claim 13, wherein the sealing layer comprises a plurality of seal holes, and wherein the frame comprises a plurality of seal compression control pins operative to interface with the plurality of seal holes.

22. The sealed contact structure of claim 21, wherein the interface between the plurality of seal holes and the plurality of seal compression control pins provides a predefined sealing tightness of the sealing layer to the frame.

23. The sealed contact structure of claim 13, wherein the sealing layer is operative to receive the force from a switch mechanism of the switch apparatus.

24. A method of manufacturing a sealed contact structure, the method comprising:
positioning a first contact away from a second contact by a predefined distance;
integrating each of the first contact and the second contact to a frame such that a first portion of the first contact is fixed to the frame, and a second portion of the first contact is (i) exposed in an opening of the frame and (ii) free to move within the frame to interact with the second contact over the predefined distance; and
disposing a sealing layer onto the frame to seal the opening.

25. The method of claim 24, wherein the positioning comprises orienting one of the first contact and the second contact such that the second portion of the first contact is adjacent to the second contact.

26. The method of claim 24, wherein the integrating comprises insert molding each of the first contact and the second contact into the frame.

27. The method of claim 24, wherein the integrating comprises exposing respective electrical pads of the first contact and the second contact.

28. The method of claim 24, wherein the disposing comprises:
aligning a plurality of seal compression control pins of the frame with a corresponding plurality of seal holes of the sealing layer; and
coupling the plurality of seal compression control pins to the corresponding plurality of seal holes.

29. The method of claim 24 further comprising, prior to the disposing, applying an adhesive to one of the frame and the sealing layer.

30. The method of claim 29, wherein the disposing comprises sandwiching the applied adhesive between the frame and the sealing layer.

31. An electronic device comprising:
a housing having a switch opening;
a switch apparatus coupled to the switch opening and comprising a slide mechanism and a contacts component, the contacts component having a pair of electrical contacts sealed from the slide mechanism by a seal, and the slide mechanism being operative to interact with the seal to cause the pair of contacts to trigger a switch event.

32. The electronic device of claim 31 further comprising a pair of brackets sandwiching the contacts component within the housing and securing the slide mechanism along the switch opening such that the slide mechanism is slidable within the opening.

33. The electronic device of claim 31, wherein the contacts component further comprises a structural frame integrated with the pair of electrical contacts, the seal being disposed on the structural frame.

34. The electronic device of claim 31, wherein the slide mechanism comprises a roller and is operative to interact with the seal via the roller.

35. The electronic device of claim 31, wherein the pair of electrical contacts comprises:
a stationary contact; and
a deflectable contact operative to deflect to interact with the stationary contact when the slide mechanism interacts with the seal.

36. The electronic device of claim 35, wherein the slide mechanism is operative to transition between a first state and a second state.

37. The electronic device of claim 36, wherein, when the slide mechanism transitions from the first state to the second state, the slide mechanism interacts with the seal to deflect the deflectable contact.

38. The electronic device of claim 37, wherein, when the slide mechanism transitions from the second state to the first state, the slide mechanism interacts with the seal to undeflect the deflectable contact.

39. A method of integrating a sealed switch apparatus with a device, the method comprising:
securing a sealed contact structure of the switch apparatus to an inner bracket;
coupling an outer bracket to the inner bracket to sandwich the secured sealed contact structure between the outer bracket and the inner bracket;
situating a slide mechanism of the switch apparatus adjacent to an opening of a housing of the device; and
fixing the inner bracket to the housing to sandwich the inner bracket, the sealed contact structure, and at least a portion of the slide mechanism between the inner bracket and the housing.

40. The method of claim 39, wherein the securing comprises securing the sealed contact structure to a recess of the inner bracket.

41. The method of claim 39, wherein the securing comprises securing a post of the sealed contact structure to a corresponding hole in the inner bracket.

42. The method of claim 39, wherein the coupling comprises welding the outer bracket to the inner bracket.

43. The method of claim 39, wherein the fixing comprises screwing the inner bracket to the housing.

44. The method of claim 39 further comprising integrating a plurality of intermediate layers between the slide mechanism and the outer bracket.
